(19) United States
(12) Patent Application Publication
(10) Pub. No.: US 2010/0107506 A1
(43) Pub. Date: May 6, 2010

(54) Double Sealing Lip for Door Module of a Motor Vehicle Door

(75) Inventors: Marcus Wirthwein, Creglingen (DE); Gerhard Kirchner, Munnerstadt (DE)

Correspondence Address: PAUL AND PAUL, 2000 MARKET STREET, SUITE 2900, PHILADELPHIA, PA, 19103, US

(73) Assignee: WIRTHWEIN AG, Creglingen (DE)

(21) Appl. No.: 12/526,813

(22) PCT Filed: Feb. 4, 2008
(86) PCT No.: PCT/EP2008/000866

§ 371 Date: Aug. 12, 2009

(30) Foreign Application Priority Data
Feb. 16, 2007 (DE) 20 2007 002 572.6

(51) Int. Cl. E06B 7/16; B60J 5/04

(52) U.S. Cl. 49/475.1

(57) ABSTRACT

The invention relates to a vehicle door consisting of a body separated into a wet region and a dry region, and to an associated door module. The vehicle door has a body separated into a wet region and a dry region, the wet region being defined on one side by the door covering and on the other side by a door module, and the dry region being connected to the part separating the wet region and the dry region in the direction of the interior door moulding. The wet/dry region separating part comprises at least one double sealing lip arranged on the door module, said lip consisting of soft plastic and sealing the dry region twice from the door covering.

The invention relates to a motor vehicle door having a door body that is separated into a wet space and a dry space, and relates to a door module therefor.

Generally known are motor vehicle doors constructed in a shell-like manner that comprise an inner and outer sheet in which the inner sheet of the interior side is recessed over a large surface area. This recessed section is covered with an interior door molding. Since it is not possible to ensure that no water will penetrate into the door interior along the side window, the interior door molding must be sealingly attached to the interior sheet so that this water cannot travel into the passenger compartment.

In accordance with DE 101 33 420 A1, a door seal is to be arranged between the interior door molding and the adjacent body such that this door seal seals the vehicle interior directly against the vehicle exterior and provided in the lower region of the vehicle door is at least one drain opening through which water that accumulates in the interior space of the vehicle door can drain directly to the outside of the vehicle. In other words, all of the sealing against dust and water occurs at the door seal between interior door molding and body. This is intended to render unnecessary a second door seal outside of the seal for the interior door molding.

Such motor vehicle doors that do not have any separation of wet space from dry space are generally equipped with electrical assemblies and electrical connectors in a so-called wet-space design that results in higher costs compared to the dry-space design.

DE 199 54 648 A1 proposed a solution in which a door interior lining that forms the wet space/dry space separation for the vehicle door and/or a corresponding door interior module/device support made of plastic has at least one air-permeable pressure equalizing element. This pressure equalizing element is air-permeable and in the opposite direction is impermeable for water and dust. The pressure equalizing element can also be a component of a foam film that is provided as a sealing element and that is preferably applied from the side of the dry space to a mechanical support and thus forms the actual wet space/dry space separation. The pressure equalizing element can also be integrated into the interior door molding in order to close an opening between the wet space and the dry space. For wet space/dry space separation, the opening can also be encircled by an elastic seal disposed therebetween. This structure is relatively complex and because of its function always needs a precise seat for the seal.

The underlying problem of the invention is to ensure a high-quality wet space/dry space separation and at the same time to provide a cost-effective door module.

In accordance with the invention, the problem is solved using the features in claims 1 and 8. The dependent claims provide refinements of the invention.

The solution includes a motor vehicle door having a door body that is separated by a wet space/dry space separation into a wet space and a dry space, the wet space being limited by the door outer lining and by a door module, and the dry space being adjacent to the wet space/dry space separation towards the interior door molding, and the wet space/dry space separation including at least one double sealing lip that is arranged on the door module and that is made of soft plastic that provides the dry space double sealing protection against the door outer lining. The solution also includes a prefabricated door module having a double sealing lip for such motor vehicle doors.

The double sealing lip, in which both lips are to be placed against the same component or against which the dry space is to be sealed, ensures that during assembly and/or with material tolerances in every case one of the two lips is in position and sealing. In practice it was frequently determined that a sealing lip can dislodge, no longer sealing.

The double sealing lip comprises soft plastic, and the door module otherwise comprises plastic that has been selected to match the function. The soft plastic is selected such that it is impermeable to water and dust, at least from the sides of the wet space towards the dry space.

For pre-assembly it is appropriate for the double sealing lip made of soft plastic to be a component of the door module, and in the best case the double sealing lip made of soft plastic is an integrally molded component of the prefabricated door module.

It can also be provided that the double sealing lip seals against the door interior side, or entire regions in which functional parts of the motor vehicle are to be arranged are sealed together.

The invention shall be explained in greater detail in the following using a schematic exemplary embodiment and the figures.

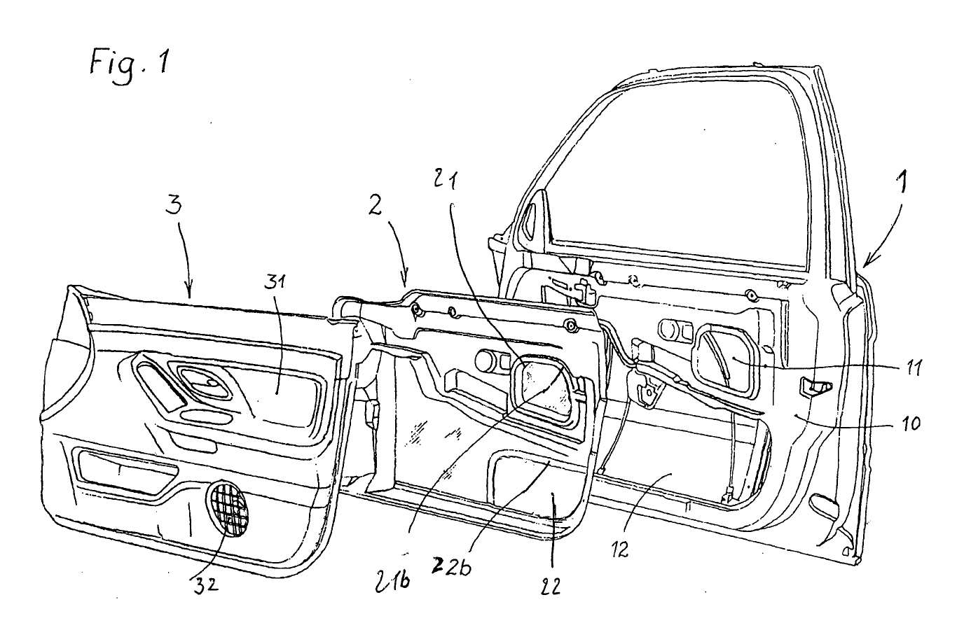

FIG. 1 is a perspective exploded drawing depicting an exterior motor vehicle door side, a device support as a plastic module—also for wet space/dry space separation—and an interior door molding;

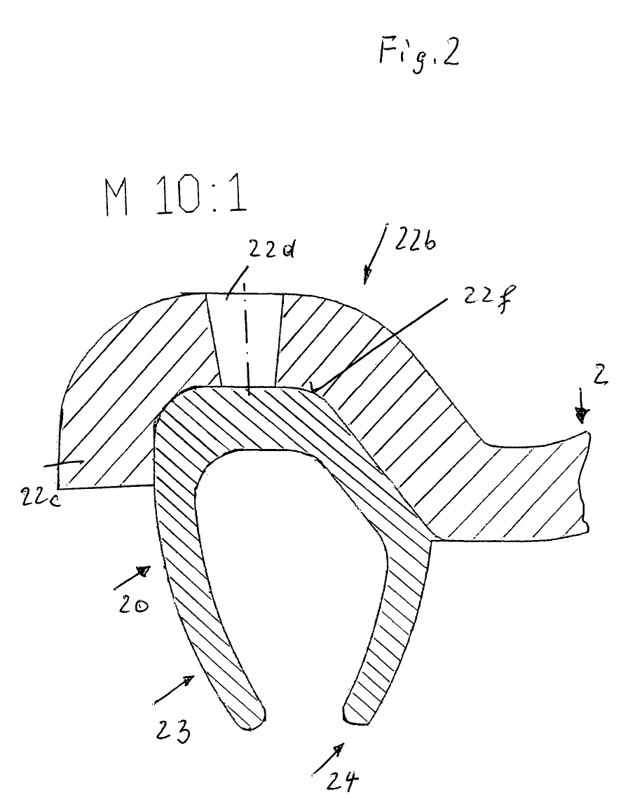

FIG. 2 is a section through an exemplary segment of a door module/support plate for functional elements, that has an inventively fitted area with double sealing lips, for an opening in the support plate.

The door body 1 depicted in FIG. 1 is comprised by an outer lining 10 that has assembly openings 11 for installing functional elements such as window lift and door lock, as well as opening 12 for a speaker. Provided as wet space/dry space separation is an air and water impermeable door module made of plastic 2 and having two partially integrally molded double sealing lip areas 21b, 22b, the upper ones encircling the assembly opening 11 while the lower ones enclose the assembly opening 12 in order to be able to receive the speaker 32 assembled on the interior door molding 3. The section 31 of the interior molding 3 then covers the installed window lift.

FIG. 2 depicts, on a 10:1 scale, a section through the double sealing lip 20, which is integrally molded in a channel 22f that is in the area 22b just in front of its edge 22c and that encircles the opening 12 in the device support 2 such that two lips 23, 24 extend about 5 mm long and 1 mm thick out of the device support 2 towards the door body 1. For this, the device support 2 in the injection molding tool is passed through by the device support 2 in the area 22b and molded thereto at an appropriate location 22d. The required core tool for forming the double sealing lip is not shown. If the device support 2 is now placed into the door body 1, it is assured that at least one of the two sealing lips 23, 24 will seal the body from the device support in a water-tight manner and thus will keep the space e.g. for the speaker 12, 22 dry, even if water from a window beads on the outside or on the inside.

1. Motor vehicle door having a door body that is separated by a wet space/dry space separation into a wet space and a dry space, the wet space being limited by the outer door lining and by a door module, and the dry space (11, 12) being adjacent to the wet space/dry space separation towards the interior door molding (3), characterized in that the wet space/dry space separation includes at least one double sealing lip (20, 23, 24) that is arranged on the door module (2) and that is made of soft plastic that provides the dry space (11, 12) double sealing protection against the door outer lining (1, 10).

2. Motor vehicle door in accordance with claim 1, characterized in that the double sealing lip (20, 23, 24) made of soft plastic is impermeable to water and dust, at least from the sides of the wet space towards the dry space (11, 12).

3. Motor vehicle door in accordance with any of the foregoing claims 1-2, characterized in that the double sealing lip (20, 23, 24) made of soft plastic is a component of the door module (2).

4. Motor vehicle door in accordance with any of the foregoing claims, 1-2 characterized in that the double sealing lip (20, 23, 24) made of soft plastic is an integrally molded component of the prefabricated door module (2).

5. Motor vehicle door in accordance with any of the foregoing claims 1-2, characterized in that the double sealing lip (20, 23, 24) seals a speaker or a door lock or a window lift drive.

6. Motor vehicle door in accordance with any of the foregoing claims 1-2, characterized in that the double sealing lip (20, 23, 24) is a component of an interior door molding (3).

7. Motor vehicle door in accordance with any of the foregoing claims 1-2, characterized in that the wet space/dry space separation of the door module (2) is formed with the double sealing lip (20, 23, 24) and sealingly covers a large-area section in which are arranged a plurality of functional components, including window lift, door lock, side airbag, speaker, electronic door control device, and/or cable trees or the like.

8. Door module having a double sealing lip (20, 23, 24) made of soft plastic as an integrally molded component of the prefabricated door module (2) for a motor vehicle door in accordance with any of the foregoing claims 1-2.
